(19) United States
(12) Patent Application Publication
(10) Pub. No.: US 2002/0195858 A1
(43) Pub. Date: Dec. 26, 2002

(54) Folding backrest for a back seat of a motor vehicle and method of making same

(76) Inventors: Dieter Jungert, Weissach (DE); Christian Danninger, Strasswalchen (AT); Peter Garnweidner, Lamprechtshausen (AT)

Correspondence Address: CROWELL & MORING LLP, INTELLECTUAL PROPERTY GROUP, P.O. BOX 14300, WASHINGTON, DC, 20044-4300, US

(21) Appl. No.: 10/155,238

(22) Filed: May 28, 2002

(30) Foreign Application Priority Data
May 28, 2001 (DE) 101 26 014.8

(51) Int. Cl. B60N 2/02

(52) U.S. Cl. 297/353

(57) ABSTRACT

A backrest is especially provided for passenger vehicles and is constructed basically continuously and executed as an extruded hollow profile with at least one profiled chamber. In order to attain a high absorption of force through the backrest, the direction of extrusion of the extruded profile runs in the direction of the backrest height.

### BACKGROUND AND SUMMARY OF THE INVENTION

This application claims the priority of German Patent Document 101 26 014.8, filed in Germany on May, 28, 2001, the disclosure of which is expressly incorporated by reference.

This invention relates to a folding backrest for a back seat of a motor vehicle wherein the backrest, viewed over a width, is constructed substantially continuously and is manufactured as an extruded hollow profile with at least one profiled chamber.

A representative backrest is described in DE 197 18 067 A1. This backrest is constructed continuously over its entire support width. There is thus no framework-like support structure, as is known from DE 197 05 603 A1. Moreover, the known backrest is manufactured as a an extruded hollow section with at least one profiled chamber. The direction of extrusion of the hollow profile runs in the direction of the backrest width.

An aspect of certain preferred embodiments of the invention is to indicate a folding backrest of the type mentioned at the beginning, which is optimized with respect to absorption of force.

This aspect is accomplished with a folding backrest which has a direction of extrusion of the extruded profile running in a direction of a backrest height. Further features characteristic for certain preferred embodiments of the invention are indicated in the dependent claims.

The advantages chiefly attained with certain preferred embodiments of the invention can be seen in that, through the direction of extrusion in the direction of the height of the backrest, a failure of the backrest, for example, a kinking or bending parallel to the transverse axis of the vehicle, is largely avoided. The profiled bars of the hollow profile running between the profiled chambers enable a high force and load absorption by the backrest. The profiled bars can be provided in regions of the backrest, which must be constructed especially rigid for a high absorption of force. For example, an edge region of the backrest can have a higher number of profiled bars. Even the thickness of the walls of the profiled bars can be adapted to load requirements. Consequently, the backrest enables a higher force or load absorption with optimized or diminished wall thickness of the hollow profile.

If the backrest is composed of several extruded profiles, which are fastened to one another, selected regions of the backrest can be designed according to force absorption demands.

In accordance with a preferred embodiment, an arching or a bending can be incorporated in an edge region of the backrest running parallel to the height of the backrest. Through arching, a free space remains between the backrest and a vehicular wall in which, for example, a seat belt roller can be arranged.

Especially with respect to safety requirements, the backrest can be provided with a headrest. The use of the extruded hollow profile with the extrusion direction proves to be especially advantageous here since the headrests can be held or guided in the profiled chambers of the hollow profile.

The headrests can be movably guided in the profiled chambers and therewith be adjustable as to height. For this purpose, guide elements of a mounting apparatus can be inserted into the profiled chambers for the headrest in accordance with a preferred embodiment. Consequently, a previously necessary reworking of the backrest in order to create recesses for these guiding elements, is advantageously eliminated.

When using the backrest in sports cars, it has proved advantageous if the headrest can be lowered into the backrest in order to improve the rear view of the driver in the case of an unused rear seat. For lowering the headrest in the backrest, this is provided with a recess open at the edge in accordance with another preferred embodiment, in which the retracted or lowered headrest will be located.

With other embodiments having the profiled chamber at least partially foam packed or with a reinforcing element, ribs or bars, it is advantageous for the backrest to be able to be constructed even more rigidly, or to enable an even higher force or load absorption. Nonetheless, a thin-walled extruded profile can be used for a further optimization of weight for the backrest.

Other objects, advantages and novel features of the present invention will become apparent from the following detailed description of the invention when considered in conjunction with the accompanying drawings.

### BRIEF DESCRIPTION OF THE DRAWINGS

FIG. 1 shows a front view of a backrest with a headrest,

FIG. 2 shows a backrest according to FIG. 1 in sectional view along line II-II, and

FIG. 3 shows a sectional view of the backrest corresponding to line III-III.

### DETAILED DESCRIPTION OF THE DRAWINGS

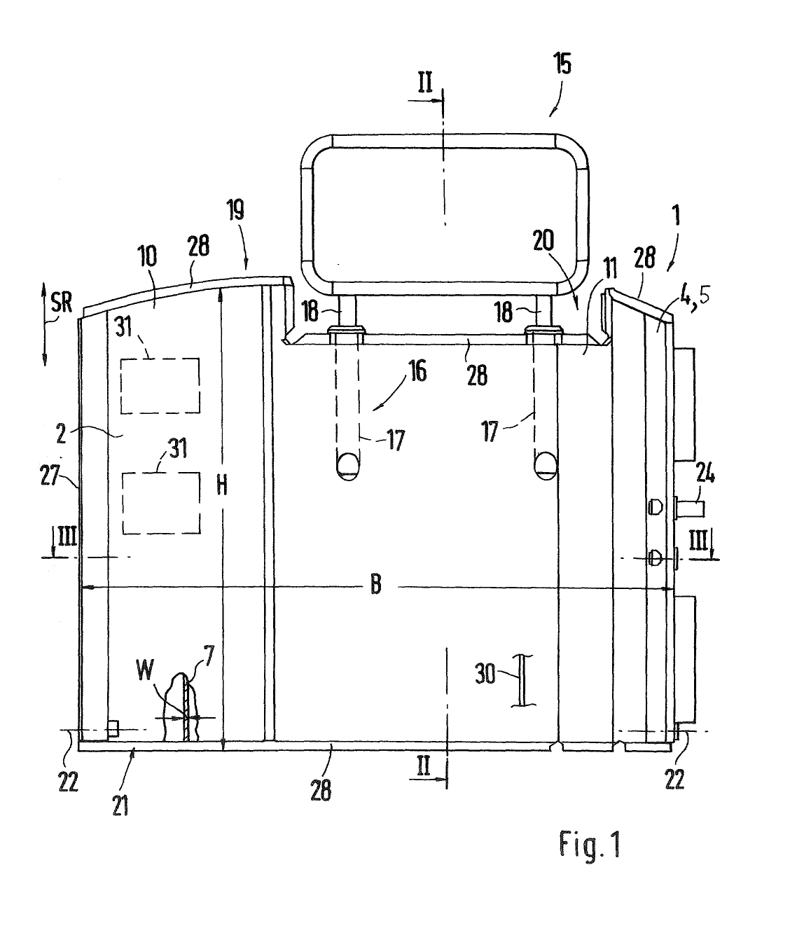

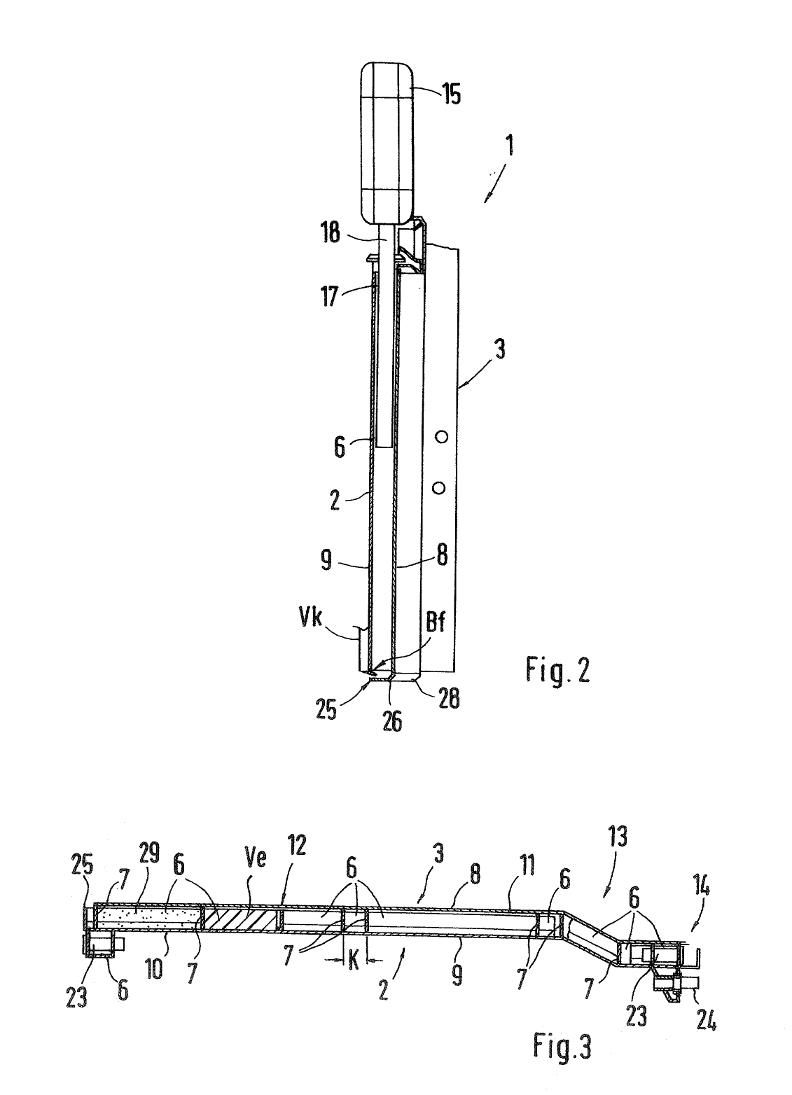

On the basis of FIGS. 1 to 3, a folding backrest 1 for a backseat of a motor vehicle not represented in greater detail here, for example a passenger car, will be explained. The backrest 1 possesses a front side 2 and a backside 3, whereby the front side of the backrest surface is allocated for an occupant and the backside is turned toward the rear region of the motor vehicle. Furthermore, the backrest 1 (viewed across its width B) is basically constructed continuously, thus as one, and made of an extruded profile 4 whose direction of extrusion SR runs in the direction of the backrest height H, thus vertically, whereby the extruded profile 4 is constructed as a hollow profile 5 with several profiled chambers 6. The profiled chambers are limited by profiled bars 7 which extend between the wall area 8 and 9 of the hollow profile 5. The profiled chambers 6 adjacent to one another extend like the profiled bars 7 along the backrest height H on the basis of the extrusion direction SR.

The backrest 1 can be made of a single extruded profile 4 or encompass several assembled extruded profiles 10 and 11, which are fastened in a connection area 12, for example, by being inserted into one another. The two extruded profile elements 10 and 11 can additionally or alternatively be joined, for example, by welding, gluing, screwing, riveting or the like.

In accordance with FIG. 3, the backrest (viewed in cross section perpendicular to the backrest height H) has an arch or bend 13 which preferably is in an edge area 14 running parallel to the height H, whereby this bending is oriented such that it protrudes beyond the plane of the front side 2 or the wall region 9.

The backrest 1 is equipped with a headrest 15, which is secured in a mounting apparatus 16 of the backrest 1 or is guided movably in this mounting apparatus, so that the headrest is adjustable as to height. The mounting apparatus 16 encompasses at least one guide element 17, which takes on the shape of a sleeve and is inserted into a profiled chamber 6 of hollow profile 5. A guide rod 18 of the headrest 15 is guided in each sleeve-like guide element. Alternatively, merely one guide element 17 and one guide rod 18 can be provided. In order to be able to lower the headrest 15 at least partially in the backrest 1, a recess 20 open at the edge is provided in the upper edge region 19 of the backrest 1 running crosswise to backrest height H. This recess can be proportioned such that it can hold the entire headrest 15.

The folding axis 22 of the backrest 1 is in a lower edge region 21 of the backrest 1 running substantially parallel to the upper edge region 19, wherein the folding axis 22 can be formed by bearing bolts 23 inserted into the hollow profile 5, with these bolts, for example, being connected in a swiveling manner with the seating surface of the backrest or with the vehicle body. In order to be able to latch or hold the backrest 1 in its upright support position corresponding to the seating position of the backrest, a locking apparatus is provided which includes a backrest-side locking element 24 and locking element (not represented) that is fixed in the vehicle. The backrest-side locking element 24 can, for example, be realized as a locking bolt, which interacts with a vehicle body side, lockable bolt seating device. Locking apparatuses of this type are known.

In order to be able to fasten paneling Vk, for example, a cover, on the extruded profile 4, a groove 25 running at least partially around the edge of the backrest 1 is provided, in which a fastening edge Bf of the backrest cover Vk can be secured, for example, by clamping it in the groove 25. For this, the fastening edge of the backrest cover can be fitted into groove 25 and the freestanding wall area 26 of groove 25 can be deformed, for example, bent. In the wall area 27 and edge area 14 of backrest 1 running parallel to the backrest height H, this peripheral groove 25 can be manufactured by extrusion or be subsequently introduced into the profile 4 by opening a profiled chamber 6. The freestanding wall area 26 can alternatively also be manufactured by extrusion. Furthermore, the wall area can be merely provided in segments so that several bars for securing the cover Vk are formed. In edge regions 19 and 21 of the backrest 1, closing elements 28 can be provided, which are fastened on the profile 4 and have this groove 25. The cover Vk preferably extends across the backside 3 of the backrest 1.

At least one of the profiled chambers 6 can be provided, at least partially, with a foam packing 29. This foam packing 29 can include foam having a metal and/or plastic and/or a ceramic. In place of the foam packing, a reinforcing element Ve can be placed in at least one of the profiled chambers 6, which, for example, is constructed as a solidified foam molded element, as a molded element having a honeycomb structure or the like. Alternatively or additionally, reinforcement ribs or bars 30 can be provided in the walls 8 and/or 9 of the backrest 1, which are manufactured by press fitting, for example. By foam packing of profiled chamber 6 or by installing the reinforcing element Ve into profiled chamber 6 or introducing ribs or bars in the walls 8 and/or 9, a subsequent local or complete reinforcement of the extruded profile 4 is possible.

In highly stressed regions of the extruded profile 4 or the backrest 1, several profiled bars 7, and therewith several profiled chambers 6, can be provided. The cross-sectional profile of the profiled chambers 6 and/or the profiled bars 7 can be selected. A highly stressed region of the backrest 1 of this type can in particular be provided in the seating area for the bearing bolts 23 or for the locking element 24. The profiled chambers 6, and consequently the profiled bars 7, are distributed proportionately to load over the backrest width B and/or over the backrest height H. The profiled chamber width K and/or the wall thickness W of the profiled bars 7 can be selected corresponding to the desired load accommodation capacity of the backrest 1.

The backrest 1 can be contoured by hot and/or cold forming, whereby through local forming, if need be, a material strengthening of the extruded profile 4 can be attained, which additionally increases the rigidity of the backrest 1. Moreover, the backrest 1 can have openings or recesses 31 produced by removing material, as is shown in FIG. 1 by dotted lines. Preferably so-called metallic wrought materials, for example aluminum or an aluminum alloy, are used for the extruded profile 4. Plastics with or without fiber reinforcement could be alternative materials for the profile 4. It is also feasible to manufacture one of the profiled elements 10 or 11 of a metallic wrought material and the other profiled element 11 or 10 of a plastic.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A folding backrest for a back seat of a motor vehicle,
wherein the backrest, viewed over a width, is constructed substantially continuously, and is manufactured as an extruded hollow profile with at least one profiled chamber, and
wherein a direction of extrusion of the extruded profile runs in a direction of a backrest height.

2. A backrest according to claim 1, wherein the backrest is manufactured from a single extruded profile.

3. A backrest according to claim 1, wherein the backrest encompasses a plurality of assembled extruded partial profiles.

4. A backrest according to claim 1, wherein, viewed in cross-section perpendicular to the backrest height, the backrest is constructed, at least in areas, in an arched or bent manner.

5. A backrest according to claim 2, wherein, viewed in cross-section perpendicular to the backrest height, the backrest is constructed, at least in areas, in an arched or bent manner.

6. A backrest according to claim 3, wherein, viewed in cross-section perpendicular to the backrest height, the backrest is constructed, at least in areas, in an arched or bent manner.

7. A backrest according to claim 4, wherein the arching or bend is in an edge area of the backrest running substantially parallel to the backrest height.

8. A backrest according to claim 1, wherein a headrest is provided.

9. A backrest according to claim 2, wherein a headrest is provided.

10. A backrest according to claim 3, wherein a headrest is provided.

11. A backrest according to claim 8, wherein a mounting apparatus for the headrest is provided.

12. A backrest according to claim 11, wherein the mounting apparatus is arranged in the profiled chamber.

13. A backrest according to claim 12, wherein at least two profiled chambers are provided, and a guide element of the mounting apparatus is inserted into each of the profiled chambers.

14. A backrest according to claim 8, wherein the backrest is provided with a recess open at an edge in an edge area running cross-wise in relation to the backrest height, in which the headrest can be located.

15. A backrest according to claim 11, wherein the backrest is provided with a recess open at an edge in an edge area running cross-wise in relation to the backrest height, in which the headrest can be located.

16. A backrest according to claim 12, wherein the backrest is provided with a recess open at an edge in an edge area running cross-wise in relation to the backrest height, in which the headrest can be located.

17. A backrest according to claim 13, wherein the backrest is provided with a recess open at an edge in an edge area running cross-wise in relation to the backrest height, in which the headrest can be located.

18. A backrest according to claim 1, wherein a locking element of a locking apparatus, which latches the folding backrest in the motor vehicle in an upright backrest position, is provided.

19. A backrest according to claim 2, wherein a locking element of a locking apparatus, which latches the folding backrest in the motor vehicle in an upright backrest position, is provided.

20. A backrest according to claim 3, wherein a locking element of a locking apparatus, which latches the folding backrest in the motor vehicle in an upright backrest position, is provided.

21. A backrest according to claim 4, wherein a locking element of a locking apparatus, which latches the folding backrest in the motor vehicle in an upright backrest position, is provided.

22. A backrest according to claim 1, wherein a groove running at least partially around an edge of the backrest, in which a backrest cover can be secured, is provided.

23. A backrest according to claim 2, wherein a groove running at least partially around an edge of the backrest, in which a backrest cover can be secured, is provided.

24. A backrest according to claim 3, wherein a groove running at least partially around an edge of the backrest, in which a backrest cover can be secured, is provided.

25. A backrest according to claim 4, wherein a groove running at least partially around an edge of the backrest, in which a backrest cover can be secured, is provided.

26. A backrest according to claim 8, wherein a groove running at least partially around an edge of the backrest, in which a backrest cover can be secured, is provided.

27. A backrest according to claim 1, wherein the profiled chambers or profiled bars are distributed proportionately to load.

28. A backrest according to claim 2, wherein the profiled chambers or profiled bars are distributed proportionately to load.

29. A backrest according to claim 3, wherein the profiled chambers or profiled bars are distributed proportionately to load.

30. A backrest according to claim 8, wherein the profiled chambers or profiled bars are distributed proportionately to load.

31. A backrest according to claim 1, wherein at least one of the profiled chambers is at least partially foam packed, or has a reinforcing element.

32. A backrest according to claim 2, wherein at least one of the profiled chambers is at least partially foam packed, or has a reinforcing element.

33. A backrest according to claim 3, wherein at least one of the profiled chambers is at least partially foam packed, or has a reinforcing element.

34. A backrest according to claim 8, wherein at least one of the profiled chambers is at least partially foam packed, or has a reinforcing element.

35. A backrest according to claim 27, wherein at least one of the profiled chambers is at least partially foam packed, or has a reinforcing element.

36. A backrest according to claim 1, wherein the backrest has reinforcement ribs or bars.

37. A backrest according to claim 2, wherein the backrest has reinforcement ribs or bars.

38. A backrest according to claim 3, wherein the backrest has reinforcement ribs or bars.

39. A backrest according to claim 27, wherein the backrest has reinforcement ribs or bars.

40. A backrest according to claim 31, wherein the backrest has reinforcement ribs or bars.

41. A motor vehicle seat, comprising a folding backrest which is constructed substantially continuously over a width, the backrest being manufactured as an extruded hollow profile with at least one profiled chamber,
wherein an extrusion direction of the extruded profile runs in a direction of a height of the backrest.

42. A motor vehicle seat according to claim 41, wherein the backrest is manufactured from a single extruded profile.

43. A motor vehicle seat according to claim 41, wherein the backrest encompasses a plurality of assembled extruded partial profiles.

44. A motor vehicle seat according to claim 41, wherein the profiled chambers or profiled bars are distributed proportionately to load.

45. A motor vehicle seat according to claim 41, wherein at least one of the profiled chambers is at least partially foam packed, or has a reinforcing element.

46. A method of making a folding backrest for a back seat of a motor vehicle, comprising:
extruding a hollow profile with at least one profiled chamber, and
providing the extruded hollow profile as the backrest whereby a direction of extrusion of the extruded profile is in a direction of a height of the backrest,
wherein the backrest, viewed over a width, is constructed substantially continuously.

47. A method according to claim 46, wherein the backrest is manufactured from a single extruded profile.

48. A method according to claim 46, wherein the backrest encompasses a plurality of assembled extruded partial profiles.

49. A method according to claim 46, wherein the profiled chambers or profiled bars are distributed proportionately to load.

50. A method according to claim 46, wherein at least one of the profiled chambers is at least partially foam packed, or has a reinforcing element.
